(19) United States
(12) Patent Application Publication
(10) Pub. No.: US 2021/0158237 A1
(43) Pub. Date: May 27, 2021

(54) UTILITY LINE MAINTENANCE AND SAFETY

(71) Applicant: X Development LLC, Mountain View, CA (US)

(72) Inventors: Joel Fraser Atwater, Danville, CA (US); Leo Francis Casey, San Francisco, CA (US); Page Furey Crahan, San Francisco, CA (US); Andre Michel Hamrah, Menlo Park, CA (US); Peter Light, San Francisco, CA (US)

(21) Appl. No.: 17/104,939

(22) Filed: Nov. 25, 2020

Related U.S. Application Data
(60) Provisional application No. 62/940,994, filed on Nov. 27, 2019.

(51) Int. Cl. G06Q 10/06; G06Q 50/06; G06F 16/29

(52) U.S. Cl. CPC G06Q 10/0635; G06F 16/29; G06Q 50/06

(57) ABSTRACT

Methods, systems, and apparatus, including computer programs encoded on a computer storage medium, for performing vegetation management processes. The processes can include obtaining first data identifying vegetation growth proximate to utility lines. The processes can include identifying a set of trees as being likely to interfere with a respective utility line near the tree. The processes can include determining, for each tree in the set of trees, an impact score that indicates a severity of a power outage that would be caused by interference of the tree with a power line. The processes can include selecting, based on the impact scores, individual trees to be trimmed. The processes can include generating trimming data that includes the location of the tree on a graphical map, and providing the trimming data for display on the one or more computing devices.

### CROSS-REFERENCE TO RELATED APPLICATION

This application claims the benefit of the filing date of U.S. Provisional Application No. 62/940,994, filed on Nov. 27, 2019. The contents of U.S. Application No. 62/940,994 are incorporated herein by reference in their entirety.

### BACKGROUND

Utility System operators maintain electrical distribution systems, electrical transmission systems, and data communication systems. For example, electrical distribution systems distribute electricity from the transmission system to end users (via the poles seen in neighborhoods). Vegetation growing near the electrical wires pose a significant safety, fire, and reliability risk. As a result, system operators spend significant effort cutting vegetation to prevent it from coming in contact with wires. A common way to do this is for a forester/arborist to patrol the length of a utility line, and mark the trees that need to be trimmed, either with spray paint or ribbons. At some later time, a tree cutting crew will follow the same path, look for these markings, and cut the trees.

### SUMMARY

In general, the disclosure relates to a vegetation management system that can predict vegetative interference with utility lines. For example, a vegetation management system can estimate the growth of individual trees proximate to utility lines within a geographic region. Based on the predicted growth, the vegetative management system can identify individual trees with increased risk of utility line interference. For routine utility maintenance, a vegetation management system can generate prospective vegetation trimming data on a routine basis, e.g., weekly, monthly, quarterly. Such prospective vegetation trimming data may, for example, provide a geographic map identifying the locations of individual trees that will require routine trimming within the routine time period, e.g., weekly, monthly, etc.

In some examples, the vegetation management system can generate emergency vegetation trimming data, for example, in response to a predicted weather event. For instance, the vegetative management system can use the predicted growth of individual trees to identify a subset of high-risk trees which, while perhaps not yet in need of routine trimming, will likely interfere with the utility lines due to the impending weather event. For example, such modeling can weigh each tree's predicted growth against additional information including, but not limited to, the geometry between the tree and utility line, the type of soil around the tree, the status (e.g., moisture content) of the soil around the tree, the water table, the tree species, the state of utility lines, characteristics of the impending weather event, the architecture of the utility grid proximate the tree, or combination thereof. The emergency vegetation trimming data can include, e.g., a heat map indicating prioritized cutting regions in advance of the weather event, images of the individual high-risk trees with a graphical overlay identifying the high-risk tree and, in some examples, individual branches to be cut.

Particular implementations of the subject matter described in this specification can be implemented so as to realize one or more of the following advantages. Implementations may provide more precise and efficient management of vegetation near utility lines. Implementations may improve the reliability of utility service, in particular, during severe weather events. Implementations may prevent utility outages caused by vegetative inference with utility lines. Implementations may provide for reliable advance warning of potential utility outages. Implementations may permit those affected by possible utility outages to take proper precautions.

The details of one or more implementations of the subject matter of this disclosure are set forth in the accompanying drawings and the description below. Other features, aspects, and advantages of the subject matter will become apparent from the description, the drawings, and the claims.

### DESCRIPTION OF DRAWINGS

FIG. 1 depicts a block diagram of an example vegetation management system.

FIG. 2 depicts a flowchart of an exemplary process for predicting vegetative interference with utility lines.

FIG. 3 depicts different exemplary vegetation/utility line geometries.

FIG. 4 depicts a schematic diagram of a computer system that may be applied to any of the computer-implemented methods and other techniques described herein.

Like reference numbers and designations in the various drawings indicate like elements.

### DETAILED DESCRIPTION

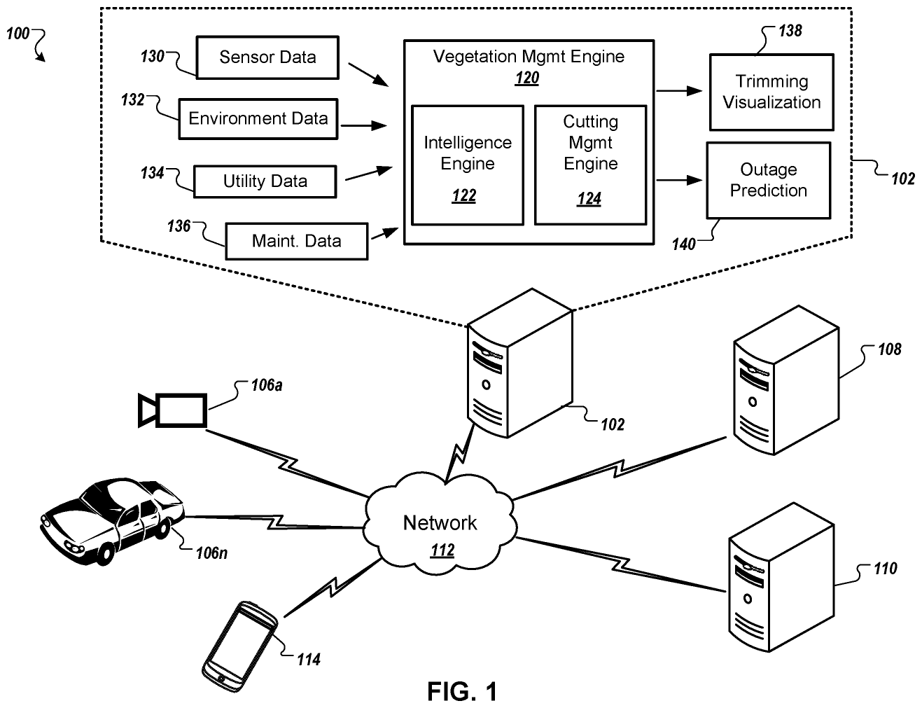

FIG. 1 is a diagram that illustrates an example of vegetation management system 100 for predicting the spread of contagions. The system 100 includes a server system 102 in communication with a plurality of sensors 106a-106n (collectively 106), one or more user computing devices 114, one or more weather systems 108, and one or more utility data systems 110. Server system 102 communicates with sensors 106, weather system 108 and utility data system 110 over a network 112. Network 112 can include public and/or private networks and can include the Internet.

The server system 102 can include a system of one or more computers. The server system 102 is configured to predict vegetative interference with utility lines either on a routine basis or in response to an impending weather event. For example, the server system 102 can store and execute one or more machine learning engines that are programed to predict vegetative interference with utility lines and generate trimming visualization data and/or utility outage alerts by performing the processes described below.

Sensors 106 can be mobile or fixed sensors. For example, sensors 106 can include, but are not limited to, smart phones, tablet computers, fixed web-liked cameras (e.g., utility pole mounted cameras), line sag detectors, drone mounted sensors, LIDAR sensors, vehicle mounted cameras (e.g., street view cameras), environmental sensors, and soil monitoring sensors. Sensors 106 can obtain and transmit sensor data 130 including, but not limited to, imagery data, geographical location data (e.g., GPS data), stereoscopic imagery, hyperspectral imagery, local environment data, local soil data, local weather data, etc.

The weather system 108 can be a server or a network of servers that hosts and executes a weather monitoring or prediction system. The weather system 108 can be a third-party system, operated independently of the server system 102. The server system 102 can communicate with one or more weather systems 108 to obtain location specific weather data 132 and/or weather prediction data.

The utility data system 110 can be a server or a network of servers that hosts and executes utility monitoring system and/or utility database. The utility data system 110 can be a third-party system, operated independently of the server system 102. The server system 102 can communicate one or more utility data system 110 to obtain location based utility data 134. For example, the utility data 134 can include, but is not limited to, utility usage data, utility architecture data, etc. The utility usage data represents a time-based usage of a utility lines at various locations within a utility network, e.g., current draw for power lines or data usage communication lines. Utility architecture data represents the architecture of the utility network at various locations. For example, the utility architecture data can provide the number and type of loads that are fed by different portions of the utility lines.

User computing devices 114 can be smartphones, tablet computers, laptop computers, desktop computers, government or community alert computing systems, or other user computing devices. For example, user computing devices 114 can be used by utility maintenance crews, or owned by a homeowner. The server system 102 can communicate with user computing devices 114 to obtain, for example, images of vegetation that is proximate to utility lines from a home owner or to communicate an upcoming vegetation trimming schedule with a home owner subscribed to receive utility maintenance notifications. In some examples, the server system 102 can send outage prediction alerts 140 to user computing devices 114 that are subscribed to receive such alerts. In some examples, the server system 102 can communicate with user computing devices 114 to obtain trimming maintenance data 136 from utility maintenance crews and to send trimming visualization data 138 to utility maintenance crew computing devices 114. For example, the maintenance data 136 can include trimming audit data indicating, for example, individual trees that were cut (e.g., graphically annotated image data) and location data (e.g., GPS data indicating the location of trees that were trimmed).

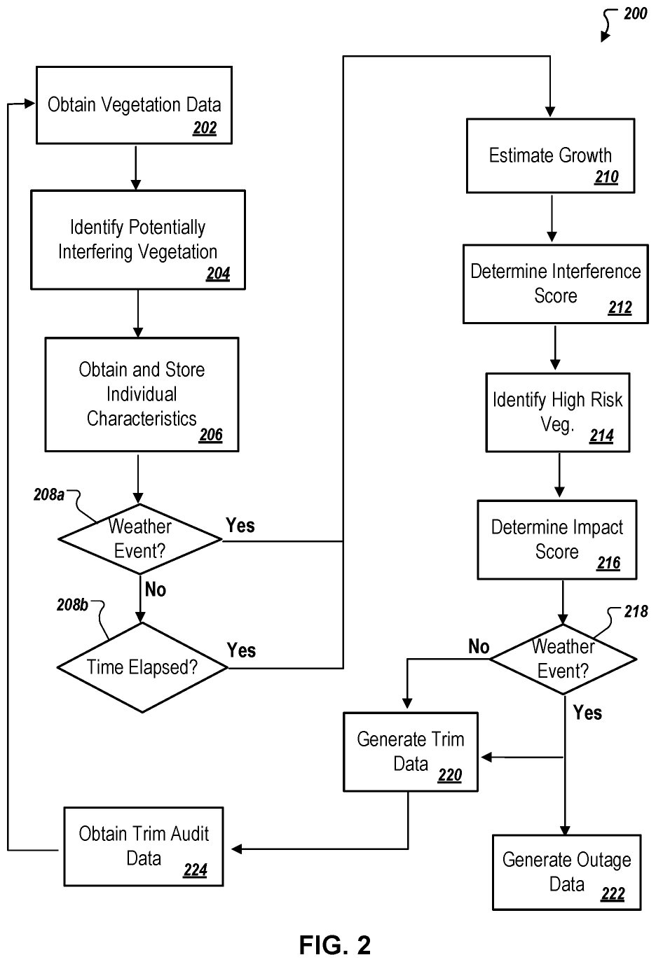

In various implementations, server system 102 can perform some or all of the operations related to predicting vegetative interference with utility lines. For example, server system 102 can include a vegetation management engine 120. Vegetation management engine 120 can implement the processes described below in reference- to FIG. 2 for predicting vegetative interference with utility lines and generating trimming visualization output 138. Vegetation management engine 120 can also implement one or more machine learning engines that analyze various types of input data (130-136) to predict vegetative interference with utility lines and generate trimming visualization data 138 and/or outage prediction alerts 140. For example, vegetation management engine 120 can include an intelligence engine 122 and a cutting management engine 124. Intelligence engine 122 and cutting management engine 124 can be implemented as separate machine learning engines or as two modules of one machine learning engine.

More specifically, vegetation management engine 120 includes one or more machine learning models that have been trained to receive model inputs (e.g., sensor data 130, weather data 132, utility data 134, maintenance data 136) and generate a predicted output (e.g., individual tree growth estimates, vegetation interference scores, identifying high risk vegetation, interference impact scores, trimming data, or outage predictions) based on the received model input. In some implementations, the machine learning model is a deep model that employs multiple layers of models to generate an output for a received input. For example, the machine learning model may be a deep neural network. A deep neural network is a deep machine learning model that includes an output layer and one or more hidden layers that each apply a non-linear transformation to a received input to generate an output. In some cases, the neural network may be a recurrent neural network. A recurrent neural network is a neural network that receives an input sequence and generates an output sequence from the input sequence. In particular, a recurrent neural network uses some or all of the internal state of the network after processing a previous input in the input sequence to generate an output from the current input in the input sequence. In some other implementations, the machine learning model is a shallow machine learning model, e.g., a linear regression model or a generalized linear model.

FIG. 2 depicts a flowchart of an example process 200 for predicting vegetative interference with utility lines in accordance with implementations of the present disclosure. In some implementations, the process 200 can be provided as one or more computer-executable programs executed using one or more computing devices. In some examples, process 200 is executed by one or more machine learning models. In some examples, the process 200 is executed by one or more computers of a vegetation management system 100. Portions of process 200 can be implemented by various sub-systems of a vegetation management system 100 such as a vegetation management engine 120, an intelligence engine 122, or a cutting management engine 124.

The system obtains vegetation data (202). For example, the vegetation management engine 120 obtains vegetation data associated with vegetation proximate to utility lines in one or more geographic regions. For example, vegetation management engine 120 obtains the sensor data 130 and maintenance data 136 from sensors 106 and user computing devices 114. Sensors 106 can obtain and transmit the sensor data 130 to the server system 102. Senor data can include, but is not limited to, imagery data, geographical location data (e.g., GPS data), stereoscopic imagery, hyperspectral imagery, local environment data, local soil data, local weather data, etc. The server system 102 can communicate with user computing devices 114 to obtain trimming maintenance data 136 from utility maintenance crews and to send trimming visualization data 138 to utility maintenance crew computing devices 114. For example, the maintenance data 136 can include trimming audit data indicating, for example, individual trees that were cut (e.g., graphically annotated image data) and location data (e.g., GPS data indicating the location of trees that were trimmed).

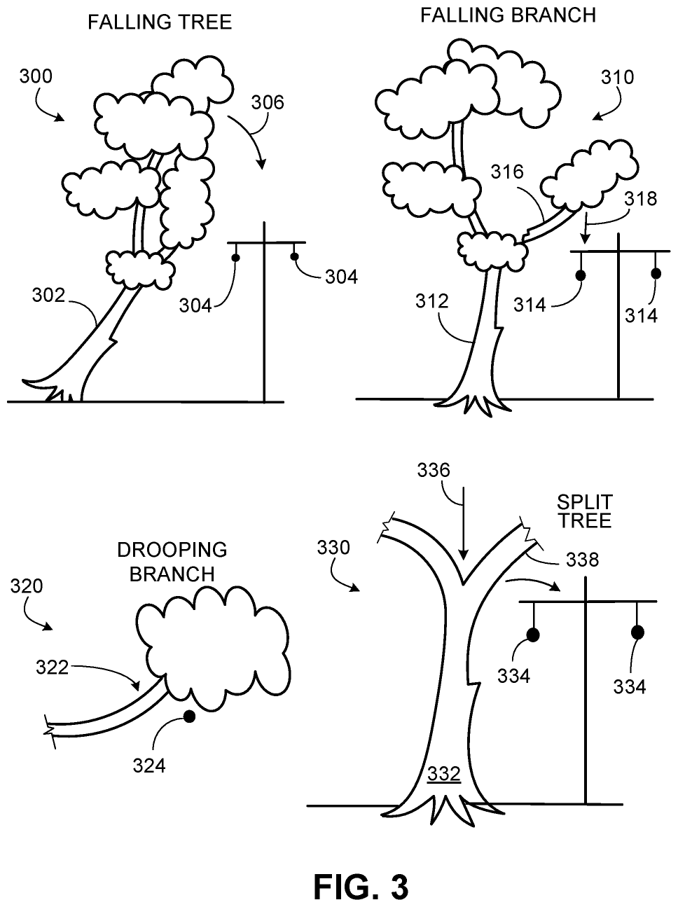

The system identifies potentially interfering vegetation (204). For example, the system identifies, from the vegetation data, individual trees that have the potential to interfere with nearby utility lines based on factors including, but not limited to, proximity to the utility lines, geometry between the tree and the utility lines, tree species, local environmental data, seasonal changes, vegetation growth models, or a combination thereof. For example, intelligence engine 122 can perform analytics on the vegetation data to identify individual trees by geographic location that are at risk of interfering with nearby utility lines. In some examples, intelligence engine 122 can perform image analysis to identify trees with branches that are within a threshold proximity of utility lines. In some examples intelligence engine can identify through image analysis different tree to utility line geometries that create a risk of interference with nearby utility lines (e.g., as illustrated in FIG. 3 and described below).

In some examples, intelligence engine 122 builds a database of the identified potentially interfering vegetation. For example, intelligence engine 122 can build a database that labels each of the identified trees linking them to geospatial location data and images of the tree obtained through the vegetation data.

The system obtains and stores individual vegetation characteristics (206). For example, intelligence engine 122 can extract individual tree characteristics from the vegetation data. Tree characteristics can include, but is not limited to, geographical location of the tree (e.g., a GPS location), an image of the tree, a tree type (E. G., coniferous or deciduous), the tree species, the type of soil around the tree, and initial proximity between the tree and a utility line, a geometry between the tree and the utility line, a growth model for the tree, or a combination thereof. Characteristics such as the geographical location, image, and type of soil may be obtained directly from the vegetation data. In some examples, the intelligence engine 122 can overlay notations on the image of the tree. For example if a particular image includes multiple trees that are predicted to potentially interfere with utility line the intelligence engine 122 may annotate the image with a label separately identifying each tree.

The intelligence engine 122 can extract other information from the vegetation data such as the tree type, the tree species, the distance between the tree and the utility line, and the geometry between the tree in the utility line. For example, the intelligence engine 122 can implement an image analysis model to identify data such as the tree type and/or species from images of the trees. In some implementations, the intelligence engine 122 can analyze multiple images in order to determine an initial distance between the tree and the utility line.

In some implementations, intelligence engine 122 can use image analysis and/or hyperspectral imagery data received from the sensors 106 to determine the health of individual trees. For example, different spectral profiles can be used to indicate whether a tree is diseased or otherwise unhealthy. In some examples, the image analysis model can be used in combination with seasonal, weather, or environmental data from the trees location to determine the health of the tree. For example, such data can be used to analyze the trees foliage and determine the health of the tree. As an example, a tree with foliage that is prematurely browning based on the present season may indicate an unhealthy tree. As another example, dead or dying tree branches of an otherwise healthy tree may be identified by foliage analysis.

In another example, intelligence engine 122 can implement an image analysis model to identify one or more potentially hazardous geometries between the tree and the utility line. For example, differing types of geometries between a tree and utility line may create different risk profiles of the tree interfering with utility line and various different circumstances. FIG. 3 depicts different exemplary vegetation/utility line geometries 300, 310, 320, and 330. Geometry 300 illustrates a falling tree geometry. In the following tree geometry, for example tree 302 does not pose an immediate interference risk with utility line 304. That is, tree 302 is a sufficient distance from the utility line 304 that it's branches do not create an immediate risk of interference. However, the tree's 302 height in relation to the utility line 304, in addition to the fact that there are no other trees to potentially support the tree 302 if it fell, creates a risk that tree 302 will impact the utility line 304 if it falls in the direction indicated by arrow 306. In some examples, the following tree geometry may represent a minimal risk under normal conditions. However, such a geometry may be logged for individual trees because the risk associated with this geometry may be elevated by a weather event that has high winds.

Geometry 310 illustrates a falling branch geometry. For example, tree 312 is taller than the height of utility line 314, and again is sufficiently distant from the utility line 3142 not pose an immediate interference risk. In addition, tree 312 may not even pose a risk of growing into the utility line 314 since the majority of its branches are already above utility line 314. However, because some of its branches 316 are directly above utility line 314 tree 312 may possibly interfere with utility line 314 if the branches 316 were to break and fall. For example, the following branch geometry may become a high risk if the tree's health decays, if any of the branches above utility line 314 become diseased or damaged, or during weather with high winds.

Geometry 320 illustrates a drooping branch geometry. Geometry 320 is similar to geometry 310, however, branch 322 is closer to utility line 324 in the drooping branch geometry. The drooping branch geometry may pose a more elevated risk to the utility line 324 even under normal conditions. The drooping branch geometry tree may also pose elevated risks in similar scenarios to the falling branch geometry, discussed above. In addition, the drooping branch geometry may pose an elevated risk to the utility line 324 during low wind conditions. For example, the drooping branch may pose a risk of drooping into the utility line 324 under icy or snowy conditions when the ice or snow increases the weight of the branch causing it to droop into the utility line 324. The risk posed by this geometry may be further elevated if the ice or snow comes early in a season when the foliage is still on the tree.

Geometry 330 illustrates a split tree geometry. For example, tree 332 has two large trunks separated in a joint 336. Under normal conditions, tree 332 may pose minimal risk to the utility line 334. For example, unless the tree's health deteriorates, the tree trunks may be sufficiently strong to pose a minimal risk. However, in the split tree geometry, a quick freeze after heavy rain may cause ice to build up in the joint 336 as the ice expands it may cause the tree to split further potentially cracking it and causing trunk 338 to fall on the utility line 334. Consequently, the split tree geometry may primarily pose an elevated risk in the event of a quick freeze after heavy rainfall. In another example, the split in tree 332 may have been due to damage to the tree, for example, a lightning strike. In some implementations, intelligence engine 122 can identify the difference, for example, by the coloration around the split in the tree. In such cases, the split tree geometry may pose a more elevated risk under normal and severe weather conditions.

In some examples, each tree geometry is assigned a geometry risk score that may be modified or weighted based on changes in environmental conditions, weather conditions, the health of the tree, or a combination thereof. In some examples, tree geometries can be used to sort or categorize individual trees into risk groups associated with particular types of weather events. That is, the tree geometries can be used as a factor to more efficiently sort and identify high-risk trees prior to severe weather.

Referring again to FIG. 2, the intelligence engine 122 can compile the tree characteristics discussed above for each individual tree and store them in a vegetation database. For example, intelligence engine 122 can convert the data to a unified and structured format that links each tree's label or identity (e.g., a tree identifier number) with its respective characteristics (e.g., protobuf, database schema, JSON, csv, etc.).

The vegetation management engine 120 can, routinely or upon a trigger event, analyze the population of trees contained in the tree database to predict a set of trees that are at a heightened risk of interfering with utility lines and generate trimming data for prioritized cutting of trees within the set. For example, on routine time intervals 208b, (e.g., weekly, monthly, quarterly, etc.) the vegetation management engine 120 can identify a set of high-risk trees and generate appropriate trimming data. In some examples, the vegetation management engine 120 can identify high-risk trees and generate appropriate trimming data in response to a trigger event such as impending severe weather 208a. In some examples, the identification of high-risk trees and generation of trim data in response to a trigger event may be given priority over the generation of routine trimming data. In addition, when generating trim data in response to a trigger event such as impending weather, the vegetation management engine 120 may apply different input data and/or conduct different analyses than when generating routine trimming data. For example, various risk scores, such as the geometry risk scores discussed above, can be modified or weighted differently based on the context of a particular trigger event.

The system estimates growth of individual trees (210). For example, the intelligence engine 122 can apply a growth model to estimate the growth of trees stored in the vegetation database. In some examples, the intelligence engine 122 can apply the growth model to each tree in a particular geographic region. For example, the intelligence engine 122 can apply the growth model to each tree in a particular geographic region that will be affected by the predicted trigger event or a particular geographic region due for routine trimming.

The intelligence engine 122 can use the growth model to estimate a change in the relationship between each tree and its related utility line. For example the intelligence engine can use the growth model to estimate a change in distance between branches of the tree and its related utility line over a given time period. For example, the intelligence engine 122 can apply a machine learning based growth model using the tree characteristics stored in the vegetation database. For example, the growth model can account for variables such as the tree type/species, location, local weather conditions (e.g., rainfall) over a period of time since the latest data was obtained for a tree, soil type, soil conditions, water table, or combination thereof.

The system determines interference scores (212). For example, the intelligence engine 122 can predict the probability of each tree interfering with its respective utility lines and assign an interference score. In some examples, the interference score is the predicted probability of interference. For example, intelligence engine 122 can predict the probability of a tree interfering with its respective utility line based on factors including, but not limited to, the tree's estimated proximity to the utility line, the type of geometry between the tree and the utility line, the tree species, estimated or measured soil conditions (e.g., soil softness/moisture content), the tree's health, attributes of a trigger event, or combination thereof. The intelligence engine 122 can apply a prediction model that weights all or some of these factors against each other to arrive at the predicted probability of the tree interfering with its respective utility line.

In some examples, soil conditions at or near the location of a given tree can be estimated based on recent weather patterns within the geographical region. For example whether data can be used to estimate the moisture content of the soil around a given tree. Soil conditions can provide an indication of how likely a tree is to fall during a high wind event or other severe weather. For example, the period of heavy rain precedes an impending windstorm then the soil will likely be soft increasing the risk of the tree being uprooted and falling on the utility lines.

Attributes of a trigger event can include, but are not limited to, the type of event, expected type of precipitation, expected winds, expected wind direction, amount of precipitation, expected duration of the event, or combination thereof. As noted above, the attributes of a trigger event such as severe weather can be used to weight the risk that various different tree-to-utility line geometries pose to interference with a utility line.

The system identifies high-risk vegetation (214). For example, the intelligence engine 122 can send the tree interference scores to the cutting management engine 124. The cutting management engine 124 can identify a set of trees that pose a high risk of interference with utility lines based on their respective interference score. For example, the cutting management engine 124 can parse the potentially interfering trees in the geographical region based on their respective interference score. In some examples, the cutting management engine 124 filters the trees into a set of high-risk vegetation based on a high-risk threshold value.

The cutting management engine 124 can apply a predetermined high-risk threshold value or adaptively generate one. For example, the cutting management engine 124 can assign all trees with an interference score greater than the threshold value (e.g., 50%) to sets of high-risk trees. As another example, the cutting management engine 124 can statistically determine a threshold value based on the variation of interference scores. For example, the cutting management engine 124 can apply the mean value of all the interference scores as the threshold value. As another example the cutting management engine 124 can apply a threshold value that is a certain number of standard deviations away from the mean of the interference scores.

In some examples, the cutting management engine 124 can determine a high risk threshold value based in part on resource availability at the given time. For example when many tree trimming resources are readily available the cutting management engine 124 can select a relatively lower value, thereby, incorporating a greater number of trees in the set of high-risk trees and providing for more complete use of the resources available.

The system determines impact scores (216). For example, the cutting management engine 124 can determine impact scores associated with some or all of the trees in the set of high-risk vegetation. Impact scores can represent the potential impact that each tree would cause if it were to interfere with its respective utility line. For example, cutting management engine 124 can use utility data such as utility architecture information to determine respective impact scores for the trees in the set of high-risk vegetation. Utility architecture information indicates the number and type of loads supplied by various portions of the utility lines near the respective trees. For example, a tree near a utility line supplying power to a critical load such as a hospital may be assigned a higher impact score than a utility line supplying data services to a small rural neighborhood.

The system generates trim data (220). For example, the cutting management engine 124 can prioritize individual trees or regions/groups of trees for trimming based on available trimming resources. For example, trimming resources can include the availability of utility maintenance crews and/or contractors available to perform trimming operations. The cutting management engine 124 combines an individual tree's interference score and impact score to determine a prioritization score. For example, cutting management engine 124 can multiply the interference score and impact score to compute the prioritization score. The cutting management engine 124 uses the prioritization score to rank individual trees into a trimming priority list.

The cutting management engine 124 can generate trim visualization data based on individual tree locations and their respective prioritization score. For example, the cutting management engine 124 can generate a geographical heat map using the tree locations and their respective prioritization score. The trimming visualization data can be sent to user computing devices associated with trimming crews to aid in identifying particularly important regions or locations for trimming.

In some implementations, the trimming visualization data can include the geographic heat map overlaid with links to annotated trimming imagery data of the individual trees within the high-priority regions of the map. For example, the trimming imagery data can include images, or links to images, of the individual high-risk trees that include annotations of the particular branches that are estimated to interfere with the utility line.

The system obtains trim audit data (224). In some implementations, the trimming visualization data can be provided to the users through a unique trimming application on the user computing device. The trimming application can provide an interface for trimming crews to upload audit data while they perform the work trimming the trees. For example, as a crew finishes trimming a particular tree identified by the heat map they can capture an updated photograph of the tree using the user computing device and upload the image along with identification of label of the tree that was cut to the vegetation management system 120.

In some implementations, the vegetation management system 120 can also generate outage prediction data (222). For example, in response to a trigger event such as severe weather (218) the vegetation management system 120 can generate outage prediction data based on the tree prioritization scores and the utility architecture information. For example, when trimming resources are insufficient to trim all of the high-risk trees in a given region prior to severe weather, the vegetation management system 120 can use the utility architecture data associated with trees that have relatively lower prioritization scores (meaning they are unlikely to be trimmed prior to the severe weather), to identify utility customers who may be impacted by an outage during the weather event. The vegetation management system 120 can then send appropriate alerts to the computing devices of individual customers who are likely to be impacted and/or to government or community computer systems to alert appropriate communities of potential outages. In some examples, the vegetation management system 120 can use the trimming audit data to update outage alerts in real time as crews progress through trimming the trees in the affected geographical region.

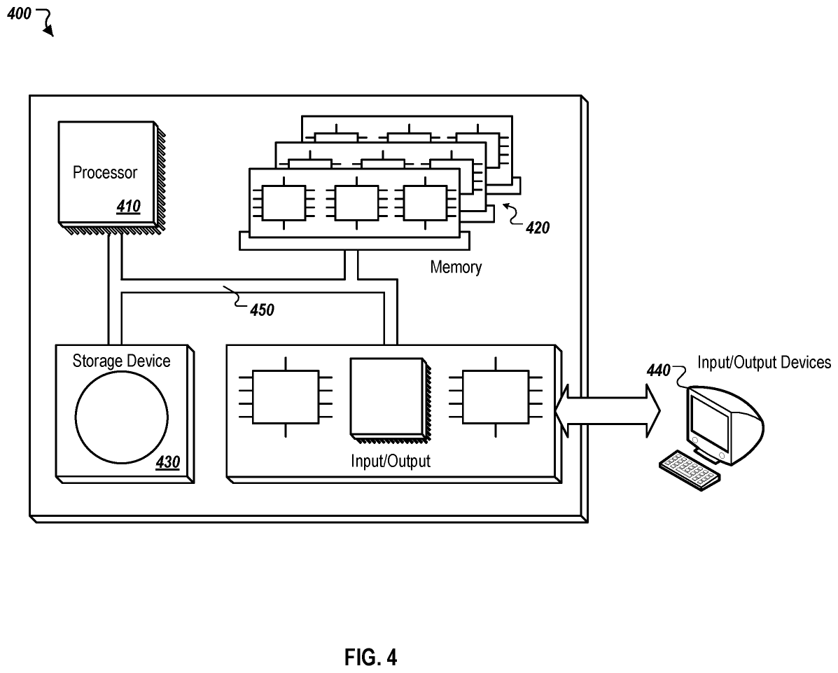

FIG. 4 is a schematic diagram of a computer system 400. The system 400 can be used to carry out the operations described in association with any of the computer-implemented methods described previously, according to some implementations. In some implementations, computing systems and devices and the functional operations described in this specification can be implemented in digital electronic circuitry, in tangibly-embodied computer software or firmware, in computer hardware, including the structures disclosed in this specification (e.g., system 400) and their structural equivalents, or in combinations of one or more of them. The system 400 is intended to include various forms of digital computers, such as laptops, desktops, workstations, personal digital assistants, servers, blade servers, mainframes, and other appropriate computers, including vehicles installed on base units or pod units of modular vehicles. The system 400 can also include mobile devices, such as personal digital assistants, cellular telephones, smartphones, and other similar computing devices. Additionally, the system can include portable storage media, such as, Universal Serial Bus (USB) flash drives. For example, the USB flash drives may store operating systems and other applications. The USB flash drives can include input/output components, such as a wireless transducer or USB connector that may be inserted into a USB port of another computing device.

The system 400 includes a processor 410, a memory 420, a storage device 430, and an input/output device 440. Each of the components 410, 420, 430, and 440 are interconnected using a system bus 450. The processor 410 is capable of processing instructions for execution within the system 400. The processor may be designed using any of a number of architectures. For example, the processor 410 may be a CISC (Complex Instruction Set Computers) processor, a RISC (Reduced Instruction Set Computer) processor, or a MISC (Minimal Instruction Set Computer) processor.

In one implementation, the processor 410 is a single-threaded processor. In another implementation, the processor 410 is a multi-threaded processor. The processor 410 is capable of processing instructions stored in the memory 420 or on the storage device 430 to display graphical information for a user interface on the input/output device 440.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 may be a floppy disk device, a hard disk device, an optical disk device, or a tape device.

The input/output device 440 provides input/output operations for the system 400. In one implementation, the input/output device 440 includes a keyboard and/or pointing device. In another implementation, the input/output device 440 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer. Additionally, such activities can be implemented via touchscreen flat-panel displays and other appropriate mechanisms.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include a local area network (“LAN”), a wide area network (“WAN”), peer-to-peer networks (having ad-hoc or static members), grid computing infrastructures, and the Internet.

The computer system can include clients and servers. A client and server are generally remote from each other and typically interact through a network, such as the described one. The relationship of client and server arises by virtue of computer programs running on the respective computers and having a client-server relationship to each other.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub combinations. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

In addition to the embodiments described above, the following embodiments are also innovative:

Embodiment 1 is a method comprising: obtaining first data identifying vegetation growth proximate to utility lines in a geographical region; identifying, from the first data, a set of trees, from among a population of trees within the geographical region, as being likely to interfere with a respective utility line near the tree; determining, for each tree in the set of trees, an impact score that indicates a severity of a power outage that would be caused by interference of the tree with a power line; selecting, based on the impact score of each tree in the set trees, individual trees to be trimmed; and generating, for each of the individual trees to be trimmed, trimming data that includes the location of the tree on a graphical map; and sending, to one or more computing devices, the trimming data for display on the one or more computing devices.

Embodiment 2 is the method of Embodiment 1, wherein identifying the set of trees comprises, for each tree in the population of trees: determining, based on one or more factors, whether the individual tree has the potential to interfere with a utility line, wherein the one or more factors include one or more of: a proximity of the tree to the nearby utility line, a geometry between the tree and the utility line, a species of the tree, local environmental data, seasonal changes, and a vegetation growth model; and responsive to determining that the individual tree does have the potential to interfere with a utility line, adding the individual tree to the set of trees.

Embodiment 3 is the method of Embodiment 1 or 2, wherein identifying the set of trees comprises identifying individual trees, within the population of trees, that are within a threshold distance of a respective utility line by performing an image analysis of images of the individual trees.

Embodiment 4 is the method of any one of Embodiments 1-3, wherein identifying the set of trees comprises identifying individual trees, within the population of trees, that form a potentially hazardous geometries between the individual tree and a respective utility line by performing an image analysis of images of the individual trees.

Embodiment 5 is the method of any one of Embodiments 1-4, wherein determining the impact score comprises identifying, for each tree in the set of trees, a number and type of loads supplied by utility lines near the respective tree and determining the impact score for the tree based on the identified number and type of loads.

Embodiment 6 is the method of any one of Embodiments 1-5, wherein the trimming data comprises a geographic map overlaid with annotations indicating locations of each tree to be trimmed.

Embodiment 7 is the method of Embodiment 6, wherein the annotations include links to images of respective trees to be trimmed.

Embodiment 8 is the method of any one of Embodiments 1-7, further comprising receiving an indication of a severe weather event, and wherein selecting the individual trees to be trimmed is performed in response to receiving the indication of the severe weather event.

Embodiment 9 is the method of any one of Embodiments 5-8, wherein identifying the set of trees from among the population of trees comprises:

for each tree in the set of trees: obtaining, from the first data, tree characteristic data including a location of the tree, an image of the tree, and a first proximity of the tree to its respective utility line at a first time, determining, based on the tree characteristic data and a tree growth model, a second proximity of the tree to its respective utility line at a second time, and determining an interference risk score based on the second proximity of the tree to its respective utility line; and

adding trees to the set of trees based on a respective interference risk scores of the tree.

Embodiment 10 is the method of Embodiments 9, wherein determining the interference risk score based on the second proximity of the tree to its respective utility line comprises: identifying a possible contact mechanism between the tree and its respective utility line and weather data associated with the location of the tree; and determining the interference risk score based on an analysis of a) the second proximity of the tree to its respective utility line, b) the possible contact mechanism, and c) the weather data.

Embodiment 11 is a computer-implemented vegetation management method comprising: obtaining first data identifying vegetation growth proximate to utility lines in a geographical region; identifying, from the first data, a set of trees, from among a population of trees within the geographical region, as being likely to interfere with a respective utility line near the tree;

for each tree in the set of trees: obtaining, from the first data, tree characteristic data including a location of the tree, an image of the tree, and a first proximity of the tree to its respective utility line at a first time, determining, based on the tree characteristic data and a tree growth model, a second proximity of the tree to its respective utility line at a second time, and determining, at the second time, an interference risk score that indicates a likelihood that the tree will interfere with its respective utility line, each interference risk score being determined based on: the second proximity of the tree to its respective utility line, a possible contact mechanism between the tree and its respective utility line, and weather data associated with the location of the tree;

identifying, based on the interference risk score of each tree, a subset of high risk trees; determining, for each tree in the subset of high risk trees and based on a utility connectivity model at the location of the tree, an impact score that indicates a severity of a power outage that would be caused by interference of the tree with a power line; selecting, based on the impact score and the interference risk score of each tree in the subset of high risk trees, individual trees to be trimmed; generating, for each of the individual trees to be trimmed, trimming data that includes the location of the tree on a graphical map and the image of the tree; and sending, to one or more computing devices, the trimming data for display on the one or more computing devices.

Embodiment 12 is a system comprising: one or more computers and one or more storage devices storing instructions that are operable, when executed by the one or more computers, to cause the one or more computers to perform the method of any one of embodiments 1 to 11.

Embodiment a non-transitory computer readable storage medium storing instructions that, when executed by at least one processor, cause the at least one processor to perform the method of any one of embodiments 1 to 11.

What is claimed is:

1. A computer-implemented vegetation management method executed by a computing system and comprising:
obtaining first data identifying vegetation growth proximate to utility lines in a geographical region;
identifying, from the first data, a set of trees, from among a population of trees within the geographical region, as being likely to interfere with a respective utility line near the tree;
determining, for each tree in the set of trees, an impact score that indicates a severity of a power outage that would be caused by interference of the tree with a power line;
selecting, based on the impact score of each tree in the set trees, individual trees to be trimmed;
generating, for each of the individual trees to be trimmed, trimming data that includes the location of the tree on a graphical map; and
sending, to one or more computing devices, the trimming data for display on the one or more computing devices.

2. The method of claim 1, wherein identifying the set of trees comprises, for each tree in the population of trees:
determining, based on one or more factors, whether the individual tree has the potential to interfere with a utility line, wherein the one or more factors include one or more of: a proximity of the tree to the nearby utility line, a geometry between the tree and the utility line, a species of the tree, local environmental data, seasonal changes, and a vegetation growth model; and
responsive to determining that the individual tree does have the potential to interfere with a utility line, adding the individual tree to the set of trees.

3. The method of claim 1, wherein identifying the set of trees comprises identifying individual trees, within the population of trees, that are within a threshold distance of a respective utility line by performing an image analysis of images of the individual trees.

4. The method of claim 1, wherein identifying the set of trees comprises identifying individual trees, within the population of trees, that form a potentially hazardous geometries between the individual tree and a respective utility line by performing an image analysis of images of the individual trees.

5. The method of claim 1, wherein determining the impact score comprises identifying, for each tree in the set of trees, a number and type of loads supplied by utility lines near the respective tree and determining the impact score for the tree based on the identified number and type of loads.

6. The method of claim 1, wherein the trimming data comprises a geographic map overlaid with annotations indicating locations of each tree to be trimmed.

7. The method of claim 6, wherein the annotations include links to images of respective trees to be trimmed.

8. The method of claim 1, further comprising receiving an indication of a severe weather event, and
wherein selecting the individual trees to be trimmed is performed in response to receiving the indication of the severe weather event.

9. The method of claim 1, wherein identifying the set of trees from among the population of trees comprises:
for each tree in the set of trees:
obtaining, from the first data, tree characteristic data including a location of the tree, an image of the tree, and a first proximity of the tree to its respective utility line at a first time,
determining, based on the tree characteristic data and a tree growth model, a second proximity of the tree to its respective utility line at a second time, and
determining an interference risk score based on the second proximity of the tree to its respective utility line; and
adding trees to the set of trees based on a respective interference risk scores of the tree.

10. The method of claim 9, wherein determining the interference risk score based on the second proximity of the tree to its respective utility line comprises:
identifying a possible contact mechanism between the tree and its respective utility line and weather data associated with the location of the tree; and
determining the interference risk score based on an analysis of a) the second proximity of the tree to its respective utility line, b) the possible contact mechanism, and c) the weather data.

11. A system comprising:
at least one processor; and a data store coupled to the at least one processor having instructions stored thereon which, when executed by the at least one processor, causes the at least one processor to perform operations comprising:
obtaining first data identifying vegetation growth proximate to utility lines in a geographical region;
identifying, from the first data, a set of trees, from among a population of trees within the geographical region, as being likely to interfere with a respective utility line near the tree;
determining, for each tree in the set of trees, an impact score that indicates a severity of a power outage that would be caused by interference of the tree with a power line;
selecting, based on the impact score of each tree in the set trees, individual trees to be trimmed;
generating, for each of the individual trees to be trimmed, trimming data that includes the location of the tree on a graphical map; and
sending, to one or more computing devices, the trimming data for display on the one or more computing devices.

12. The system of claim 11, wherein identifying the set of trees comprises, for each tree in the population of trees:
determining, based on one or more factors, whether the individual tree has the potential to interfere with a utility line, wherein the one or more factors include one or more of: a proximity of the tree to the nearby utility line, a geometry between the tree and the utility line, a species of the tree, local environmental data, seasonal changes, and a vegetation growth model; and
responsive to determining that the individual tree does have the potential to interfere with a utility line, adding the individual tree to the set of trees.

13. The system of claim 11, wherein identifying the set of trees comprises identifying individual trees, within the population of trees, that are within a threshold distance of a respective utility line by performing an image analysis of images of the individual trees.

14. The system of claim 11, wherein identifying the set of trees comprises identifying individual trees, within the population of trees, that form a potentially hazardous geometries between the individual tree and a respective utility line by performing an image analysis of images of the individual trees.

15. The system of claim 11, wherein determining the impact score comprises identifying, for each tree in the set of trees, a number and type of loads supplied by utility lines near the respective tree and determining the impact score for the tree based on the identified number and type of loads.

16. The system of claim 11, wherein the trimming data comprises a geographic map overlaid with annotations indicating locations of each tree to be trimmed.

17. The v of claim 17, wherein the annotations include links to images of respective trees to be trimmed.

18. The system of claim 11, further comprising receiving an indication of a severe weather event, and
wherein selecting the individual trees to be trimmed is performed in response to receiving the indication of the severe weather event.

19. The system of claim 11, wherein identifying the set of trees from among the population of trees comprises:
for each tree in the set of trees:
obtaining, from the first data, tree characteristic data including a location of the tree, an image of the tree, and a first proximity of the tree to its respective utility line at a first time,
determining, based on the tree characteristic data and a tree growth model, a second proximity of the tree to its respective utility line at a second time, and
determining an interference risk score based on the second proximity of the tree to its respective utility line by:
identifying a possible contact mechanism between the tree and its respective utility line and weather data associated with the location of the tree, and
determining the interference risk score based on an analysis of a) the second proximity of the tree to its respective utility line, b) the possible contact mechanism, and c) the weather data; and
adding trees to the set of trees based on a respective interference risk scores of the tree.

20. A computer-implemented vegetation management method executed by a computing system and comprising:
obtaining first data identifying vegetation growth proximate to utility lines in a geographical region;
identifying, from the first data, a set of trees, from among a population of trees within the geographical region, as being likely to interfere with a respective utility line near the tree;
for each tree in the set of trees:
obtaining, from the first data, tree characteristic data including a location of the tree, an image of the tree, and a first proximity of the tree to its respective utility line at a first time,
determining, based on the tree characteristic data and a tree growth model, a second proximity of the tree to its respective utility line at a second time, and
determining, at the second time, an interference risk score that indicates a likelihood that the tree will interfere with its respective utility line, each interference risk score being determined based on:
the second proximity of the tree to its respective utility line,
a possible contact mechanism between the tree and its respective utility line, and
weather data associated with the location of the tree;
identifying, based on the interference risk score of each tree, a subset of high risk trees;
determining, for each tree in the subset of high risk trees and based on a utility connectivity model at the location of the tree, an impact score that indicates a severity of a power outage that would be caused by interference of the tree with a power line;
selecting, based on the impact score and the interference risk score of each tree in the subset of high risk trees, individual trees to be trimmed; and
generating, for each of the individual trees to be trimmed, trimming data that includes the location of the tree on a graphical map and the image of the tree;
sending, to one or more computing devices, the trimming data for display on the one or more computing devices.
